(19) United States
(12) Patent Application Publication
(10) Pub. No.: US 2006/0200519 A1
(43) Pub. Date: Sep. 7, 2006

(54) Networked meeting recording method and apparatus

(75) Inventor: George Clement, Sterling, VA (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/074,277

(22) Filed: Mar. 7, 2005

(51) Int. Cl. G06F 15/16

(52) U.S. Cl. 709/204

(57) ABSTRACT

An apparatus is endowed with the ability to receive contents and audio of a networked meeting, and store the received contents and audio. The apparatus does not facilitate any participant to participate in the networked meeting.

### FIELD OF THE INVENTION

The present invention relates generally to the field of data processing and, in particular, to networked meeting recording methods and apparatuses.

### BACKGROUND OF THE INVENTION

Advances in microprocessor and related technologies have led to wide spread deployment and adoption of numerous general purpose as well as special purpose computing devices. General purpose computing devices, such as servers and desktop computers, are now endowed with computing power that was once reserved for the most expensive high end computers, requiring special conditioned environment to operate. At the same time, advances in networking, telecommunication, satellite, and other related technologies have also led to increase in connectivity between computing devices, making possible networked computing over private and/or public networks, such as the Internet.

An example of networked computing is networked meetings among multiple meeting participants using networked computing devices. Typically, networked meetings are conducted with the meeting participants computing devices connected to each other over a private/public network, with the connections primarily employed for data sharing. Most of the times, one of the meeting participants' computing devices will act as a host, facilitating the sharing of data among the meeting participants. Notwithstanding the significant increase in computing power of personal computers, and network bandwidth, typically, the networked meetings are still conducted with the data connections supplemented with separate parallel connections to a bridge, using telephone handsets, for audio exchange among the meeting participants.

As with conventional in-person meetings, it is often desirable to record a meeting. However, due the resource constraints, the recording can not be easily accomplished today, especially, not on one of the participants computing devices, without affecting the effective participation of the participant in the networked meeting.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a flow chart view of the operational flow of the networked meeting manager of the host device of FIG. 1 in accordance with various embodiments;

FIG. 3 illustrates a flow chart view of the operational flow of the networked meeting recorder of the networked meeting recording device of FIG. 1 in accordance with various embodiments;

FIG. 4 illustrates a flow chart view of the operational flow of the networked meeting recording manager of the server of FIG. 1 in accordance with various embodiments; and

FIG. 5 illustrates an example computing device suitable for use as either the host device, one of the participant devices, the networked meeting recording device, the server device or one of the client devices of FIG. 1, for practicing the invention, in accordance with various embodiments.

### DETAILED DESCRIPTION OF ILLUSTRATIVE EMBODIMENTS

Illustrative embodiments of the present invention include but are not limited to methods for recording a networked meeting, and apparatuses adapted to practice these methods in part or in whole.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

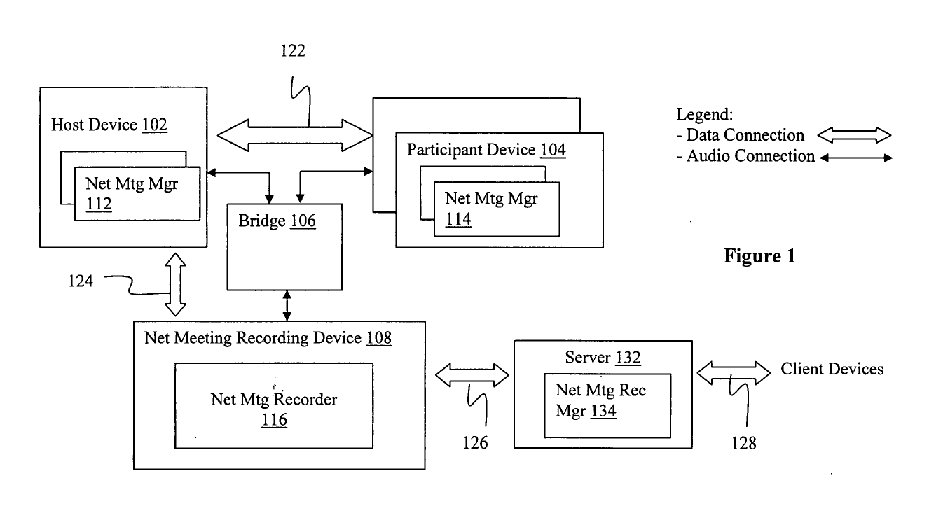

Referring now to FIG. 1, wherein an overview of the present invention, in accordance with various embodiments, is shown. As illustrated, for the embodiments, participants (not shown) engaged with each other in a networked meeting using corresponding host device 102 and one or more participant devices 104 coupled to each other. Typically, the participants (not shown) are the users of the coupled corresponding devices, i.e. host device 102 and one or more participant devices 104.

Additionally, participants of the networked meeting employ integrated or complementary audio communication devices (not shown), such as telephone handsets, operatively coupled to bridge 106, to audibly communicate with each other.

Further, for the illustrated embodiments, networked meeting recording device 108 is employed to facilitate recording of the networked meeting. As shown, networked meeting recording device 108 is also coupled to host device 102 and bridge 106. The former coupling is employed to receive a copy of the data being shared among the coupled devices, whereas the later coupling is employed to received a copy of the audio being exchanged between the participants, thereby allowing them to be recorded. The data may e.g. be originated from presenters of the various participant devices 104. The data is also referred to as the content of the networked meeting.

In various embodiments, networked meeting recording device 108 is adapted for that purpose, i.e. the recording of networked meetings being its primary purpose. In various embodiments, networked meeting recording device 108 is not employed by any participant to participate in the networked meetings it records. Accordingly, networked meeting recording device 108 may also be referred to as a non-participant networked meeting device.

However, in alternate embodiments, a user may nonetheless use networked meeting recording device 108 to participate in a networked meeting it is recording, or to participate in a networked meeting, when the device is not used to record the networked meeting. Further, in alternate embodiments, networked meeting recording device 108 may also be adapted for other secondary purpose(s).

Continuing to refer to FIG. 1, host device 102 and participant devices 104 are endowed with networked meeting managers 112 and 114 respectively. In various embodiments, networked meeting manager 112 differs from networked meeting manager 114, in that, in addition to standard networked meeting functions, networked meeting manager 112 is endowed with host functions to host networked meetings. In alternate embodiments, they are the same, that is, all having the hosting functions. However, for each networked meeting, only the host functions of device to act in the role of the host are employed.

In various embodiments, to complement embodiments of networked meeting recording device 108 that are adapted primarily for the purpose of recording networked meetings, and not employed by participants to participate in networked meetings it records, networked meeting manager 112 is adapted to recognize networked meeting recording device 108 as a special type of participants, i.e. a device participant.

Still referring to FIG. 1, networked meeting recording device 108 is endowed with networked meeting recorder 116, equipped to receive the data and audio of the networked meeting, combine them into a single media stream, and save the stream as a file, to be described more fully below. Additionally, for the embodiments, networked meeting recording device 108 is also coupled to server 132 endowed with recording manager 134, and networked meeting recorder 116 is further endowed with functions to register a recording with recording manager 134, as well as transferring the recording to recording manager 134 for extended or permanent storage. In alternate embodiments, the recording methods of the present invention may be practiced without networked meeting recorder 116 transferring the recordings to recording manager 134 for extended or permanent storage.

In various embodiments, in particular, embodiments where networked meeting manager 112 have not been further endowed to recognize networked meeting recording device 108 as a special type of device participant of a networked meeting, networked meeting recorder 116 may be further endowed with the ability of emulating a participant. Accordingly, networked meeting recording device 108 may also be referred to as pseudo participant device of a networked meeting.

For the embodiments, server 132 is also coupled to a number of client devices, which may be host or participant devices 102 and 104. Recording manager 134, in addition to being endowed with the functions to register recordings of the networked meetings, is further endowed with functions to allow client devices to query about, and/or retrieve particular ones of the stored recordings.

In various embodiments, the couplings between host device 102, participant devices 104 and networked meeting recording device 108, as well as the couplings between networked meeting recording device 108, server 132 and client devices, are effectuated through data connections established over one or more segments of one or more private and/or public network, e.g. the Internet. The data connections may be established in accordance with a number of messaging and/or transmission protocols.

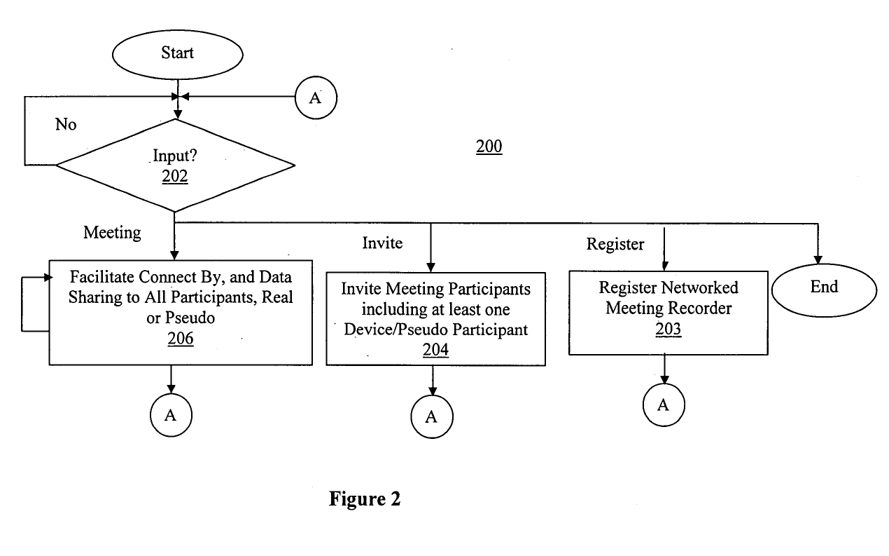

Except for networked meeting recording device 108 (including networked meeting recorder 116), complementary functions provided to networked meeting manager 112, and networked meeting recording manager 134 provided to server 132, the illustrated elements of FIG. 1 are known to those skilled in the art or otherwise within their ability to implement, accordingly will not be further described. The operating flow of enhanced networked meeting manager 112, networked meeting recorder 116, and networked meeting recording manager 134 will be described in turn in further details with references to FIGS. 2-4 respectively. Following thereafter, an example computing device suitable for use as either host device 102, participant device 104, networked meeting recording device 108, server 132 or a client device, will also be described.

Referring now to FIG. 2, wherein a flow chart illustrating a portion of the operational flow of enhanced networked meeting manager 112, in accordance with some embodiments, is shown. As illustrated, for the embodiments, on start, i.e. upon initiation on host device 102, networked meeting manager 112 awaits for inputs, block 202. On receipt of an input, networked meeting manager 112 determines the input, and proceeds accordingly.

In particular, for the embodiments, on receipt of an input to register a networked meeting recorder 116, networked meeting manager 112 registers the networked meeting recorder 116 accordingly, block 203. In various embodiments, the registration may be submitted by a user of host device 102. In other embodiments, the registration may be submitted by networked meeting recorder 116 directly. In various embodiments, the registration may also specifies the host and participant devices 102-104, the registering networked meeting recorder 116 services. Upon registering networked meeting recorder 116, the processing of networked meeting manager 112 returns to processing block 202, where networked meeting manager 112 awaits for further inputs.

However, for the embodiments, on receipt of an input to invite one or more participants to a networked meeting, networked meeting manager 112 proceeds to invite the specified participants, block 204. Additionally, in various embodiments, networked meeting manager 112 also invites networked meeting recorder 116 to join the meeting at an appointed time, block 204. Upon extending the invitations, the processing of networked meeting manager 112 returns to processing block 202, where networked meeting manager 112 awaits for further inputs.

In various embodiments, the invitation may include an identifier identifying the networked meeting (may also be referred to as a session within host device 102), and an identifier identifying bridge 106.

Still referring to FIG. 2, however, if the input is associated with the commencement of an appointed networked meeting, the processing of networked meeting manager 112 proceeds to block 206, where it facilitates the appointed networked meeting. As described earlier, the facilitation include facilitating joining of the networked meeting by various participants of the networked meeting, including joining of the networked meeting by networked meeting recording device 108. As described earlier, the facilitation may include joining of the networked meeting by networked meeting recording device 108 as a special type of participant, i.e. a device participant. Additionally, the facilitation include facilitating the sharing of data among participants of the networked meeting, including sharing of the data with networked meeting recorder 116 of networked meeting recording device 108.

Typically, networked meeting manager 112 remains in processing block 206 until a meeting ends. At the end of processing block 206, the processing of networked meeting manager 112 returns to processing block 202, where networked meeting manager 112 awaits for further inputs.

Eventually, when networked meeting manager 112 receives an input to terminate its execution, e.g. from an underlying operating system service, networked meeting manager 112 ends its execution as instructed.

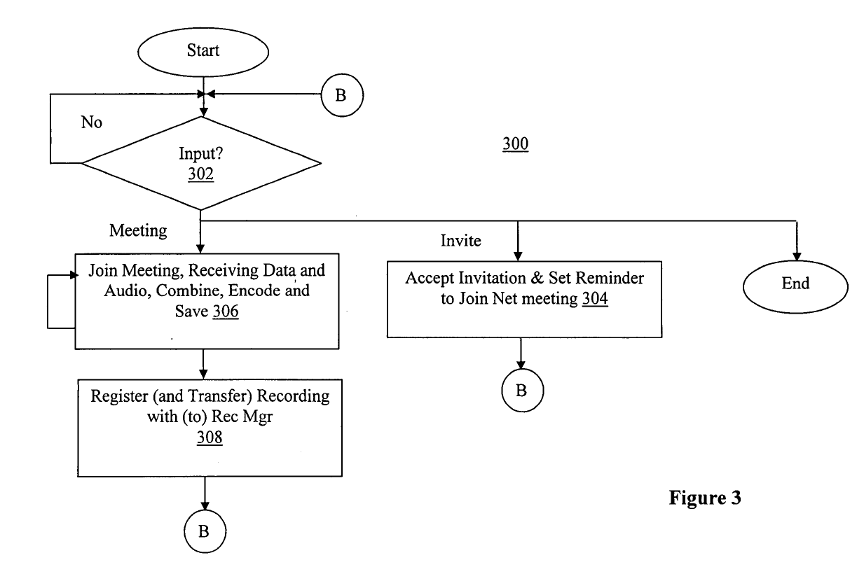

Referring now to FIG. 3, wherein a flow chart illustrating a portion of the operational flow of networked meeting recorder 116, in accordance with some embodiments, is shown. As illustrated, for the embodiments, on start, i.e. upon initiation on networked meeting recording device 108, networked meeting recorder 116 awaits for inputs, block 302. On receipt of an input, networked meeting recorder 116 determines the input, and proceeds accordingly.

In particular, for the embodiments, on receipt of an invitation to join a networked meeting, networked meeting recorder 116 sets up a reminder to join the networked meeting at the appointed time, block 304. In various embodiments, networked meeting recorder 116 sets a timer to alert itself at the appointed time. Upon setting up the reminder, the processing of networked meeting recorder 116 returns to processing block 302, where networked meeting recorder 116 awaits for further inputs.

Continuing to refer to FIG. 3, however, if the input is associated with a reminder to join an appointed networked meeting, the processing of networked meeting recorder 116 proceeds to block 306. At processing block 306, networked meeting recorder 116 joins the appointed networked meeting, including connecting to host device 102 and bridge 106, using the provided identifiers. Thereafter, as described earlier, networked meeting recorder 116 receives the data and audio associated with the networked meeting, combine and encode them into a single media stream, and save the combined media stream as a file. In various embodiments, the encoding may be performed in accordance with encoding techniques known to those of ordinary skill in the art. In various embodiments, the files are stored locally; in other embodiments, the files may be stored remotely.

Typically, the processing of networked meeting recorder 116 stays at processing block 306 until the networked meeting being recorded terminates. For the embodiments, at such time, the processing of networked meeting recorder 116 proceeds to processing block 308. At processing block 308, networked meeting recorder 116 catalogues the recording. Further, for the illustrated embodiments, networked meeting recorder 116 registers the recording with server 132, and as described earlier, transfers the recording to server 132 for extended or permanent storage.

In various embodiments, the cataloging may comprises cataloging the recordings by e.g. dates of the recordings, participants of the recordings, keywords.

Eventually, when networked meeting recorder 116 receives an input to terminate its execution, e.g. from an underlying operating system service, networked meeting recorder 116 ends its execution as instructed.

In various embodiments, back at initialization, networked meeting recorder 116 may further be endowed to discover host devices 102, and whether it has previously registered itself with the discovered host devices 102. If new host devices 102 networked meeting recorder 116 has not registered with are discovered, networked meeting recorder 116 may proceed to register itself with one or more of the newly discovered host devices 102.

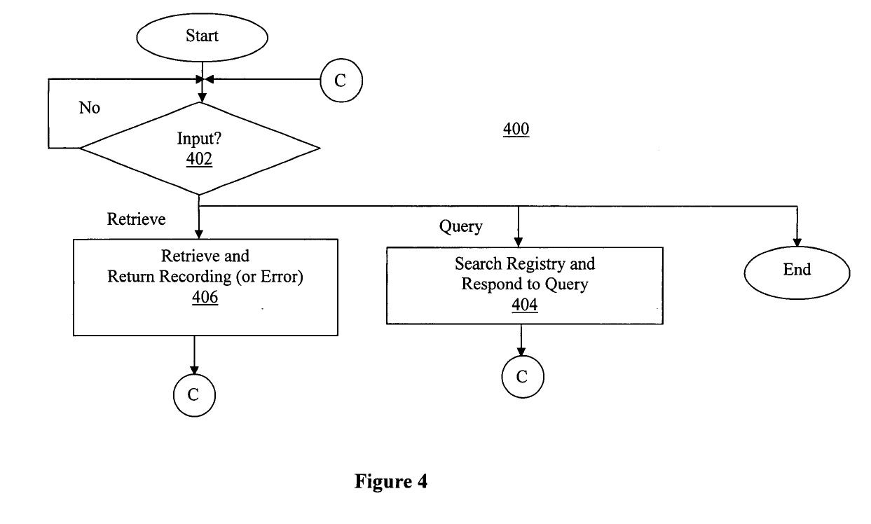

Referring now to FIG. 4, wherein a flow chart illustrating a portion of the operational flow of networked meeting recording manager 134, in accordance with some embodiments, is shown. As illustrated, for the embodiments, on start, i.e. upon initiation on server 132, networked meeting recording manager 134 awaits for inputs, block 402. On receipt of an input, networked meeting recording manager 134 determines the input, and proceeds accordingly.

In particular, for the embodiments, on receipt of request to register and/or accept transfer of a recording, networked meeting recording manager 134 processes the requested registration and/or transfer according, block 404. For example, in various embodiments, in either case, networked meeting recording manager 134 updates a catalogue of networked meeting recordings accordingly.

Continuing to refer to FIG. 4, however, if the input is associated with a query about certain networked meeting recordings or a request to retrieve a networked meeting recording, the processing of networked meeting recording manager 134 proceeds to block 406. At processing block 406, networked meeting recording manager 134 processes the query or request accordingly. In response to a query, networked meeting recording manager 134 searches its catalogue, based on the provided query parameters, and returns an answer accordingly. In response to a retrieval request, networked meeting recording manager 134 searches for the requested networked meeting recording, and returned the recording, if located, otherwise, returns an error.

Eventually, when networked meeting recording manager 134 receives an input to terminate its execution, e.g. from an underlying operating system service networked meeting recording manager 134 ends its execution as instructed.

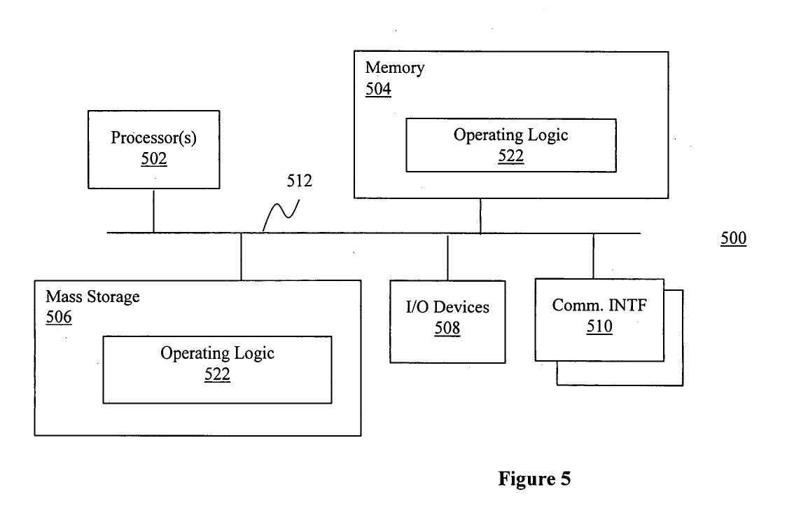

FIG. 5 illustrates a block diagram view of an example computing device suitable for use as one or more of the illustrated devices of FIG. 1, in accordance with one embodiment. As illustrated, computing device 500 includes processor 502, memory 504 coupled to each other via bus 512. Further, computing device 500 also includes mass storage device 506. I/O devices 508, and communication interface 510 coupled to the earlier described elements as shown.

Each of the elements represents a broad range of the corresponding element known in the art or to be designed consistent with the teachings of the present invention. They perform their conventional functions, i.e. processing, storage, and so forth. In particular, memory 504 and mass storage 506 are employed to store temporal and persistent copies of operating logic 522. Depending on whether computing device 500 is adapted for use as host device 102, participant device 104, networked meeting recording device 108 or server 132, operating logic 522 may be networked meeting manager 112, networked meeting manager 114, networked meeting recorder 116 and networked meeting recording manager 134 accordingly.

In various embodiments, communication interface 510 includes a networking interface. In various embodiments, for embodiments adapted for use as networked meeting recording device 108, communication interface 510 further includes at least an audio communication interface, e.g. a telephony interface, for coupling with bridge 106.

In various embodiments, for embodiments adapted for use as host device 102 or participant device 104, computing device 500 may be a desktop computer, a tablet computer or a palm sized computing device. Similarly, for embodiments adapted for use as networked meeting recording device 108, computing device 500 may be a palm sized computing device, a tablet computer, a desktop computer or a server.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. An apparatus, comprising:
a network interface to couple the apparatus to a network;
a telephony interface to couple the apparatus to a bridge; and
a recording unit coupled to the network and telephony interfaces, and adapted to
receive from a presenter participant device, a content, the presenter participant device facilitating a presenter participant's participation in a networked meeting, and the apparatus facilitating no participant's participation in the networked meeting,
receive audio of the networked meeting, and
store the received content and audio in a file.

2. The apparatus of claim 1, wherein the recording unit is further adapted to combine the content and audio into a stream, and encoding the stream.

3. The apparatus of claim 1, wherein the recording unit is further adapted to enable the apparatus to receive a request to join the networked meeting, including an appointed time of the networked meeting, and join the networked meeting, at the appointed time.

4. The apparatus of claim 3, wherein the recording unit is adapted to join the networked meeting as a device participant of the networked meeting.

5. The apparatus of claim 3, wherein the recording unit is adapted to join the networked meeting, emulating joining by a participant of the networked meeting.

6. The apparatus of claim 3, wherein the received request comprises a host name and a bridge identifier of the networked meeting, the recording unit is adapted to join the networked meeting, connecting to a host device identified by the host name, and a bridge identified by the bridge identifier.

7. The apparatus of claim 1, wherein the recording unit is further adapted to catalogue the file.

8. The apparatus of claim 7, wherein the recording unit is further adapted to catalogue the file by at least a selected one from the group consisting date, attendees and keywords.

9. The apparatus of claim 7, the recording unit is further adapted to notify a registered search engine of the catalogued file.

10. The apparatus of claim 1, wherein the recording unit is further adapted to transfer the file, after the networked meeting, to a repository.

11. An apparatus, comprising:
a network interface to couple the apparatus to a network;
a telephony interface to couple the apparatus to a bridge; and
a networked meeting hosting unit coupled to the network and telephony interfaces, and adapted to host a networked meeting, including
accepting a participant device to join a networked meeting on behalf of a participant of the networked meeting;
accepting a non-participant device to join the networked meeting on behalf of a pseudo participant of the networked meeting, the pseudo participant being a device participant or an emulated participant of the networked meeting.

12. The apparatus of claim 11, wherein the networked meeting hosting unit is further adapted to provide the non-participant device with content presented by the participant.

13. The apparatus of claim 11, wherein the networked meeting hosting unit is further adapted to send a request to the participant device and the non-participant device to join the networked meeting at an appointed time.

14. An apparatus, comprising:
a storage medium having stored therein instructions adapted to enable the apparatus to
receive from networked meeting recording devices, registrations of recordings of networked meetings, and
update a catalogue of networked meeting recordings; and
a processor coupled to the storage medium, the telephony interface and the network interface, to execute the instructions.

15. The apparatus of claim 14, wherein the instructions are further adapted to enable the apparatus to receive from network recording devices, networked meetings recording.

16. The apparatus of claim 14, wherein the instructions are further adapted to enable the apparatus to receive from client devices, queries or requests for networked meetings recording, and servicing the queries or requests.

17. A computer readable medium comprising:
a storage medium;
a plurality of instructions stored in the stored medium, the instructions being adapted to enable an apparatus to to enable the apparatus to
receive from a presenter participant device, a content, the presenter participant device facilitating a presenter participant's participation in a networked meeting, and the apparatus facilitating no participant's participation in the networked meeting,
receive audio of the networked meeting, and
store the received content and audio in a file.

18. A system comprising
a first device to facilitate hosting or participating in a networked meeting; and
a second device coupled to the first device to participate in the networked meeting as either a device participant or an emulated participant of the networked meeting.

19. The system of claim 18, wherein the system further comprises a third device coupled to the second device adapted to facilitate registration, storage, queries or retrieval of networked meeting recordings.

20. The system of claim 18, wherein the first device comprises
a networked interface to couple the first device to a network;
a telephony interface to couple the first device to a bridge;
a storage medium having stored therein instructions adapted to enable the first device to
accept the second device to join the networked meeting, and
host the networked meeting, and
a processor coupled to the storage medium, the telephony interface and the network interface, to execute the instructions.

21. The system of claim 18, wherein the second device comprises
a networked interface to couple the second device to a network;
a telephony interface to couple the second device to a bridge;
a storage medium having stored therein instructions adapted to enable the second device to
receive from the first device, a content,
receive audio of the networked meeting, and
store the received content and audio in a file; and
a processor coupled to the storage medium, the telephony interface and the network interface, to execute the instructions.

22. A method of operation to be performed on a device, comprising:
receiving by the device, from a presenter participant device, a content, the presenter participant device facilitating a presenter participant's participation in a networked meeting, and the device facilitating no participant's participation in the networked meeting;
receiving by the device, audio of the networked meeting; and
storing or causing to be stored, the received content and audio in a file.

23. The method of claim 22, wherein the method further comprises the device combining the content and audio into a stream, and encoding the stream.

24. The method of claim 22, wherein the method further comprises receiving by the device, a request to join the networked meeting, including an appointed time of the networked meeting, and joining the networked meeting by the device, at the appointed time.

25. The method of claim 22, wherein the method further comprises the device cataloguing the file.

26. The method of claim 22, further comprising the device transferring the file, after the networked meeting, to a repository.
